(19) United States
(12) Patent Application Publication
(10) Pub. No.: US 2023/0186645 A1
(43) Pub. Date: Jun. 15, 2023

(54) INTERSECTION TRAFFIC LIGHT INFORMATION DETECTION METHOD AND SYSTEM

(71) Applicant: ELECTRONICS AND TELECOMMUNICATIONS RESEARCH INSTITUTE, Daejeon (KR)

(72) Inventors: Do Wook KANG, Daejeon (KR); Jae-Hyuck PARK, Daejeon (KR); Kyoung-Wook MIN, Daejeon (KR); Kyung Bok SUNG, Daejeon (KR); Yoo-Seung SONG, Daejeon (KR); Dong-Jin LEE, Daejeon (KR); Jeong Dan CHOI, Daejeon (KR)

(21) Appl. No.: 17/993,402

(22) Filed: Nov. 23, 2022

(30) Foreign Application Priority Data
Dec. 13, 2021 (KR) 10-2021-0177939
May 10, 2022 (KR) 10-2022-0057316

(51) Int. Cl. G06V 20/58; B60W 40/04

(52) U.S. Cl. CPC G06V 20/584; B60W 40/04; B60W 2554/4046; B60W 2420/52

(57) ABSTRACT

Disclosed is a system performing a method for detecting intersection traffic light information including a traffic light detection module including an image sensor for generating first signal data based on traffic light image data in which a traffic light is included, a communication module that receives second signal data for communication with a surrounding object and an external device, an object information collection module that collects dynamic data of the surrounding object, and a signal information inference module that infers third signal data based on the dynamic data. The dynamic data of the surrounding object includes at least one information of whether the surrounding object moves, a moving direction of the surrounding object, and whether the surrounding object accelerates or decelerates. Each of the signal data includes pieces of information about a type of the traffic light and a signal direction of the traffic light.

### CROSS-REFERENCE TO RELATED APPLICATIONS

This application claims priority under 35 U.S.C. § 119 to Korean Patent Application No. 10-2021-0177939 filed on Dec. 13, 2021, and Korean Patent Application No. 10-2022-0057316 filed on May 10, 2022, in the Korean Intellectual Property Office, the disclosures of which are incorporated by reference herein in their entireties.

### BACKGROUND

### 1. Field of the Invention

Embodiments of the present disclosure described herein relate to a method and system for detecting intersection traffic light information, and more particularly, relate to a method and system for detecting intersection traffic light information that infers signal information by recognizing a behavior of a surrounding object when it is impossible to directly obtain signal information at an intersection.

### 2. Description of Related Art

In general, an autonomous driving system determines whether to enter an intersection, by detecting a traffic light through a sensor or obtaining signal information through a communication network. An existing autonomous driving system obtains signal information based on an image sensor, a camera, or the like. However, a case that a sensor of the autonomous driving system fails to recognize a traffic light in a blind spot where it is impossible to recognize the traffic light may occur. When the traffic light installed at the intersection is not working, the autonomous driving system may have difficulty in determining whether to enter an intersection.

### SUMMARY

Embodiments of the present disclosure provide a method and system for detecting intersection traffic light information that infers signal information by recognizing a behavior of a surrounding object when it is impossible to directly obtain signal information at an intersection.

According to an embodiment, a system performing a method for detecting intersection traffic light information includes a traffic light detection module including an image sensor for generating first signal data based on traffic light image data in which a traffic light is included, a communication module that receives second signal data for communication with a surrounding object and an external device, an object information collection module that collects dynamic data of the surrounding object, and a signal information inference module that infers third signal data based on the dynamic data. The dynamic data of the surrounding object includes at least one information of whether the surrounding object moves, a moving direction of the surrounding object, a moving speed of the surrounding object, and whether the surrounding object accelerates or decelerates. Each of the first signal data, the second signal data, and the third signal data includes pieces of information about a type of the traffic light, whether the traffic light is turned on, and a signal direction of the traffic light.

In an embodiment, the system further includes an intersection entry determination module that determines whether to enter an intersection, based on one signal data among the first signal data, the second signal data, and the third signal data.

In an embodiment, when the first signal data and the second signal data are not present after a vehicle enters a signal information detection area, the intersection entry determination module determines whether to enter the intersection, based on the third signal data.

In an embodiment, when the intersection entry determination module determines whether to enter the intersection based on the third signal data, the intersection entry determination module determines not to enter the intersection when the surrounding object that is present in the signal information detection area is stopped.

In an embodiment, when the intersection entry determination module determines whether to enter the intersection based on the third signal data, the intersection entry determination module determines whether enter the intersection, based on an event that the surrounding object that is present in the signal information detection area accelerates or decelerates.

In an embodiment, when the intersection entry determination module determines whether to enter the intersection based on the third signal data, the intersection entry determination module determines not to enter the intersection when the moving direction of the surrounding object that is present in the signal information detection area is perpendicular to a moving direction of the vehicle.

In an embodiment, when the intersection entry determination module determines whether to enter the intersection based on the third signal data, the intersection entry determination module determines to enter the intersection when the surrounding object that is present in the signal information detection area moves at a constant speed in the same direction as the vehicle.

In an embodiment, when the intersection entry determination module determines whether to enter the intersection based on the third signal data, the intersection entry determination module determines not to enter the intersection when the moving direction of the surrounding object that is present at the intersection is perpendicular to a moving direction of the vehicle.

In an embodiment, the first signal data, the second signal data, and the third signal data are different signal data from one another.

In an embodiment, the object information collection module includes at least one of radio detection and ranging (radar), light detection and ranging (LIDAR), and a camera.

According to an embodiment, a method for detecting intersection traffic light information includes generating, by a traffic light detection module, first signal data based on traffic light image data in which a traffic light is included, receiving, by a communication module, second signal data for communication with a surrounding object and an external device, collecting, by an object information collection module, dynamic data of the surrounding object, and inferring, by a signal information inference module, third signal data based on the dynamic data. The dynamic data of the surrounding object includes at least one information of whether the surrounding object moves, a moving direction of the surrounding object, a moving speed of the surrounding object, and whether the surrounding object accelerates or decelerates. Each of the first signal data, the second signal data, and the third signal data includes pieces of information about a type of the traffic light, whether the traffic light is turned on, and a signal direction of the traffic light.

In an embodiment, the method further includes determining, by an intersection entry determination module, whether to enter an intersection, based on one signal data among the first signal data, the second signal data, and the third signal data.

In an embodiment, the determining of whether to enter the intersection includes determining, by the intersection entry determination module, whether to enter the intersection, based on the third signal data when the first signal data and the second signal data are not present after a vehicle enters a signal information detection area.

In an embodiment, the determining, by the intersection entry determination module, of whether to enter the intersection, based on the third signal data includes determining, by the intersection entry determination module, not to enter the intersection when the surrounding object that is present in the signal information detection area is stopped.

In an embodiment, the determining, by the intersection entry determination module, of whether to enter the intersection, based on the third signal data includes determining, by the intersection entry determination module, whether enter the intersection, based on an event that the surrounding object that is present in the signal information detection area accelerates or decelerates.

In an embodiment, the determining, by the intersection entry determination module, of whether to enter the intersection, based on the third signal data includes determining, by the intersection entry determination module, not to enter the intersection when the moving direction of the surrounding object that is present in the signal information detection area is perpendicular to a moving direction of the vehicle.

In an embodiment, the determining, by the intersection entry determination module, of whether to enter the intersection, based on the third signal data includes determining, by the intersection entry determination module, to enter the intersection when the surrounding object that is present in the signal information detection area moves at a constant speed in the same direction as the vehicle.

In an embodiment, the determining, by the intersection entry determination module, of whether to enter the intersection, based on the third signal data includes determining, by the intersection entry determination module, not to enter the intersection when the moving direction of the surrounding object that is present at the intersection is perpendicular to a moving direction of the vehicle.

In an embodiment, the first signal data, the second signal data, and the third signal data are different signal data from one another.

### BRIEF DESCRIPTION OF THE DRAWINGS

The above and other objects and features of the present disclosure will become apparent by describing in detail embodiments thereof with reference to the accompanying drawings.

FIG. 1 is a diagram illustrating an intersection traffic light information detection system, according to an embodiment of the present disclosure.

FIG. 2 relates to detailed configurations for determining whether to enter an intersection, by obtaining signal information in a signal information detection area.

FIG. 3 relates to an embodiment of determining whether to enter an intersection by obtaining signal information in a signal information detection area.

FIG. 4 shows obtained signal information of FIG. 3.

FIG. 5 relates to detailed configurations for determining whether to enter an intersection, by inferring signal information in a signal information detection area.

FIG. 6A relates to a first embodiment of determining whether to enter an intersection by inferring signal information in a signal information detection area.

FIG. 6B relates to a second embodiment of determining whether to enter an intersection by inferring signal information in a signal information detection area.

FIG. 6C relates to a third embodiment of determining whether to enter an intersection by inferring signal information in a signal information detection area.

FIG. 6D relates to a fourth embodiment of determining whether to enter an intersection by inferring signal information in a signal information detection area.

FIG. 6E relates to a fifth embodiment of determining whether to enter an intersection by inferring signal information in a signal information detection area.

FIG. 7 is a flowchart of a method of generating first signal data.

FIG. 8 is a diagram illustrating a method of detecting intersection traffic light information, according to an embodiment of the present disclosure.

### DETAILED DESCRIPTION

Hereinafter, embodiments of the present disclosure may be described in detail and clearly to such an extent that an ordinary one in the art easily implements the present disclosure.

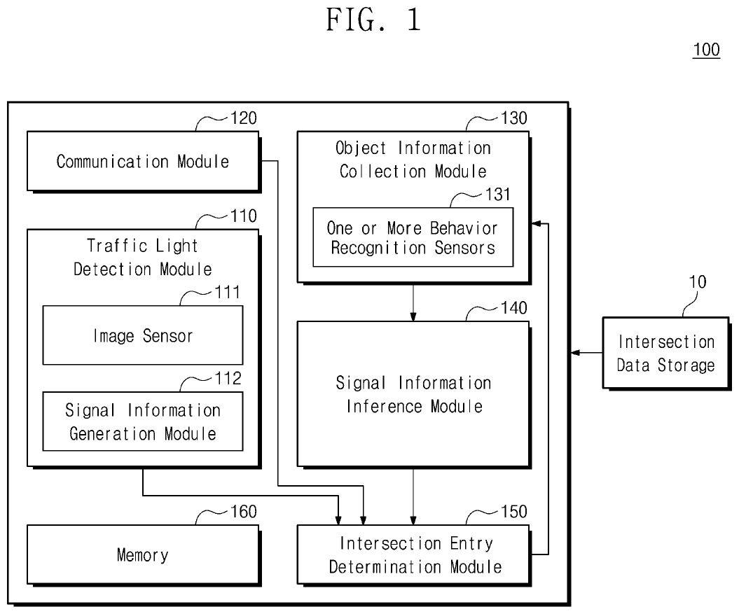

FIG. 1 is a diagram illustrating an intersection traffic light information detection system 100, according to an embodiment of the present disclosure. Referring to FIG. 1, the intersection traffic light information detection system 100 includes a traffic light detection module 110, a communication module 120, an object information collection module 130, a signal information inference module 140, an intersection entry determination module 150, and a memory 160.

The traffic light detection module 110 may include an image sensor 111 and a signal information generation module 112. The image sensor 111 included in the traffic light detection module 110 may collect image data from an external device or external system.

The image sensor 111 may include at least one image sensor. At least one image sensor may be one of a charge coupled device (CCD) image sensor and a complementary metal oxide semiconductor (CMOS) image sensor. However, the at least one image sensor is not limited thereto. For example, the at least one image sensor may include all image sensors capable of detecting data including visual information such as images, videos, and visual content.

The signal information generation module 112 may generate signal data based on image data collected by the image sensor 111. The signal information generation module 112 may generate first signal data based on traffic light image data including a traffic light among the image data.

The communication module 120 may provide remote communication with the intersection traffic light information detection system 100 and an external device or external system not included in the intersection traffic light information detection system 100. The communication module 120 may provide wired or wireless communication with the intersection traffic light information detection system 100 and an external device or external system not included in the intersection traffic light information detection system 100.

However, the intersection traffic light information detection system 100 in this specification is used to be mounted on an autonomous vehicle. It will be understood that the communication module 120 provides wireless communication with an autonomous vehicle and an external device or external system not included in the autonomous vehicle.

The communication module 120 may include a vehicle-to-infrastructure (V2I) communication network or a vehicle-to-vehicle (V2V) communication network. The communication module 120 may wirelessly communicate with at least one of an external device and an external system through the V2I communication network. The external device or external system may include city infrastructure. Alternatively, the communication module 120 may wirelessly communicate with surrounding vehicles through the V2V communication network.

The communication module 120 may receive second signal data from an external device, an external system, or surrounding vehicles through the V2I communication network and the V2V communication network. At least some of the second signal data received by the communication module 120 from an external device, an external system, or surrounding vehicles may include pieces of signal information different from the first signal data generated by the traffic light detection module 110.

The object information collection module 130 may be a device for collecting dynamic data based on recognizing behaviors of surrounding dynamic objects. The object information collection module 130 may include other sensors (hereinafter, referred to as “one or more behavior recognition sensors 131”) such as radio detection and ranging (radar), light detection and ranging (LIDAR), a distance measurement sensor, and a camera.

The one or more behavior recognition sensors 131 may recognize the behavior of a surrounding dynamic object and may collect at least one information among a moving direction of the surrounding object, a moving speed of the surrounding object, and a distance between an autonomous vehicle and the surrounding object.

The object information collection module 130 may collect dynamic data regarding a surrounding dynamic object at an intersection through the one or more behavior recognition sensors 131. The dynamic data may include at least one information of whether the surrounding object moves, a moving direction of the surrounding object, a moving speed of the surrounding object, and whether the surrounding object accelerates or decelerates.

In the present specification, the surrounding object may refer to surrounding vehicles for which the object information collection module 130 may collect dynamic data through the one or more behavior recognition sensors 131. However, the surrounding object is not limited to surrounding vehicles. For example, the surrounding object may include all surrounding dynamic means of transportation capable of collecting dynamic data through the one or more behavior recognition sensors 131.

The traffic light detection module 110, the communication module 120, and the object information collection module 130 may operate based on intersection information provided from intersection data storage 10, for example, map data.

The signal information inference module 140 may be a device for inferring signal data based on dynamic data. The signal information inference module 140 may infer third signal data based on the dynamic data collected by the object information collection module 130.

Each of the first signal data, the second signal data, and the third signal data may include pieces of information about the type of a traffic light, whether the traffic light is turned on, and a signal direction of the traffic light.

However, at least some of the third signal data inferred by the signal information inference module 140 may include signal information different from first signal data generated by the traffic light detection module 110. Besides, at least some of the third signal data inferred by the signal information inference module 140 may include signal information different from the second signal data collected by the communication module 120.

The intersection entry determination module 150 may be a device for determining whether to enter an intersection, based on signal data. The intersection entry determination module 150 may determine whether to enter an intersection, based on the first signal data generated by the traffic light detection module 110. Alternatively, the intersection entry determination module 150 may determine whether to enter an intersection, based on the second signal data collected by the communication module 120. Alternatively, the intersection entry determination module 150 may determine whether to enter an intersection, based on the third signal data inferred by the signal information inference module 140 based on dynamic object data.

The memory 160 may be a working memory of the intersection traffic light information detection system 100. The memory 160 may be implemented with various random access memories such as a dynamic random access memory, a phase change random access memory, a ferroelectric random access memory, a magnetic random access memory, and a resistive random access memory.

The memory 160 may temporarily store image data and traffic light image data. The memory 160 may temporarily store dynamic data collected by the object information collection module 130. The memory 160 may temporarily store the first signal data, the second signal data, and the third signal data.

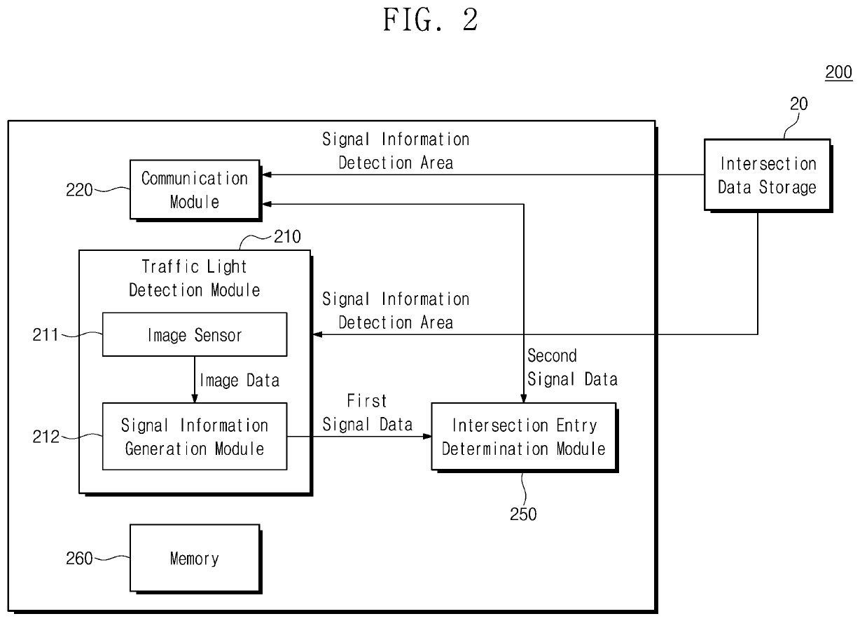

FIG. 2 relates to detailed configurations for determining whether to enter an intersection, by obtaining signal information in a signal information detection area. For example, a traffic light detection module 210, a communication module 220, an intersection entry determination module 250, and a memory 260 in FIG. 2 correspond to the traffic light detection module 110, the communication module 120, the intersection entry determination module 150, and the memory 160, respectively. Accordingly, additional descriptions of similar operations for each of the corresponding components will be omitted to avoid redundancy.

In this specification, an intersection traffic light information detection system 200 of FIG. 2 is described based on an event that the intersection traffic light information detection system 200 is mounted on an autonomous vehicle.

Referring to FIGS. 1 and 2, the intersection traffic light information detection system 200 may receive information about a signal information detection area within an intersection from intersection data storage 20 that is included in an autonomous vehicle and not included in the intersection traffic light information detection system 200.

Each of the communication module 220 and the traffic light detection module 210 may perform the operations described in FIG. 1 based on information about the signal information detection area received from the intersection data storage 20. In detail, after an autonomous vehicle enters the signal information detection area within an intersection, the traffic light detection module 210 may generate first signal data. After the autonomous vehicle enters the signal information detection area within the intersection, the communication module 220 may receive second signal data through a V2I communication network or a V2V communication network.

Alternatively, after the autonomous vehicle enters the signal information detection area within the intersection, the signal information inference module 140 may infer third signal data based on dynamic data.

After the autonomous vehicle enters the signal information detection area, the intersection entry determination module 250 may determine whether to enter an intersection, based on the first signal data generated by the traffic light detection module 210. After the autonomous vehicle enters the signal information detection area, the intersection entry determination module 250 may determine whether to enter an intersection, based on the second signal data collected by the communication module 220.

After the autonomous vehicle enters the signal information detection area, the intersection entry determination module 250 may determine whether to enter an intersection, based on one of the first signal data and the second signal data.

When the first signal data and the second signal data are not present after the autonomous vehicle enters the signal information detection area, the intersection entry determination module 250 may determine whether to enter an intersection based on the third signal data. Accordingly, detailed descriptions thereof will be omitted to avoid redundancy.

The memory 260 may temporarily store data including information about the signal information detection area.

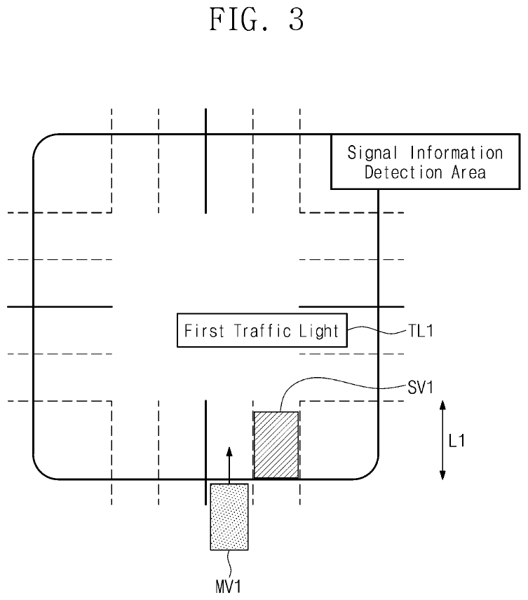

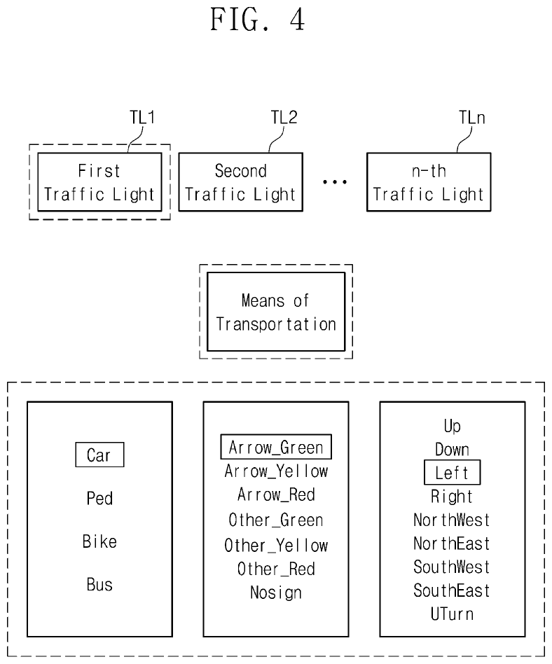

FIG. 3 relates to an embodiment of determining whether to enter an intersection by obtaining signal information in a signal information detection area. FIG. 4 shows obtained signal information of FIG. 3.

In FIG. 4, a means of transportation may be at least one of a vehicle, a bicycle, and a bus. However, the means of transportation is not limited thereto. For example, the means of transportation may include all means of transportation capable of being moved by self-generated power.

In FIG. 4, “Car” denotes a vehicle traffic light; “Ped” denotes a pedestrian traffic light; “Bike” denotes a bicycle traffic light; and, “Bus” denotes a bus traffic light. “Arrow_Green” means that a green arrow light is turned on; “Arrow_Yellow” means that a yellow arrow light is turned on; “Arrow_Red” means that a red arrow light is turned on; “Other_Green” means that a green light other than an arrow light is turned on; “Other_Yellow” means that a yellow light other than an arrow light is turned on; “Other_Red” means that a red light other than an arrow light is turned on; and, “Nosign” means that all lights are turned off.

In FIG. 4, “Up” means that the direction of an arrow light is north; “Down” means that the direction of an arrow light is south; “Left” means that the direction of an arrow light is west; “Right” means that the direction of an arrow light is east; “NorthWest” means the direction of an arrow light is northwest; “NorthEast” means the direction of an arrow light is northeast; “SouthWest” means the direction of an arrow light is southwest; “SouthEast” means the direction of an arrow light is southeast; and, “UTurn” means that the direction of an arrow light is a U-turn.

For example, the signal information detection area is shown in FIG. 3 in a two-dimensional format. For example, in FIGS. 3 and 4, only an example of obtaining signal information by detecting a first traffic light TL1 among first to n-th traffic lights TL1 to TLn is described. However, the present disclosure is not limited thereto. It will be understood that a configuration for obtaining pieces of signal information by detecting first to n-th traffic lights TL1 to TLn are also included.

Referring to FIGS. 2 to 4, an autonomous vehicle MV1 equipped with the intersection traffic light information detection system 200 may generate information about a distance L1 (hereinafter, it is referred to as a “determination distance L1”) between an intersection starting point and a signal information detection area entry point through the intersection data storage 20.

When it is determined based on the determination distance L1 that the autonomous vehicle MV1 has entered the signal information detection area, the traffic light detection module 210 may detect the first traffic light TL1 regardless of a surrounding vehicle SV1. The traffic light detection module 210 may generate first signal data based on traffic light image data including the first traffic light TL1. The first signal data may include pieces of information about the type of a traffic light, whether the traffic light is turned on, and a signal direction of the traffic light.

Although not specifically shown in drawings, for example, in FIG. 4, when the first signal data includes pieces of information indicating that the first traffic light TL1 is a vehicle traffic light, a green arrow light is turned on, and a direction of the turned-on traffic light is west, the intersection entry determination module 250 may determine to enter an intersection, while the autonomous vehicle MV1 is driving at the determination distance L1.

An embodiment of determining whether to enter an intersection based on the detected first signal data described in FIGS. 3 and 4 and pieces of signal information included in detected first signal data are only examples. The traffic light detection module 210 is not limited to the first signal data. For example, the traffic light detection module 210 may further generate pieces of signal data not represented in FIGS. 3 and 4.

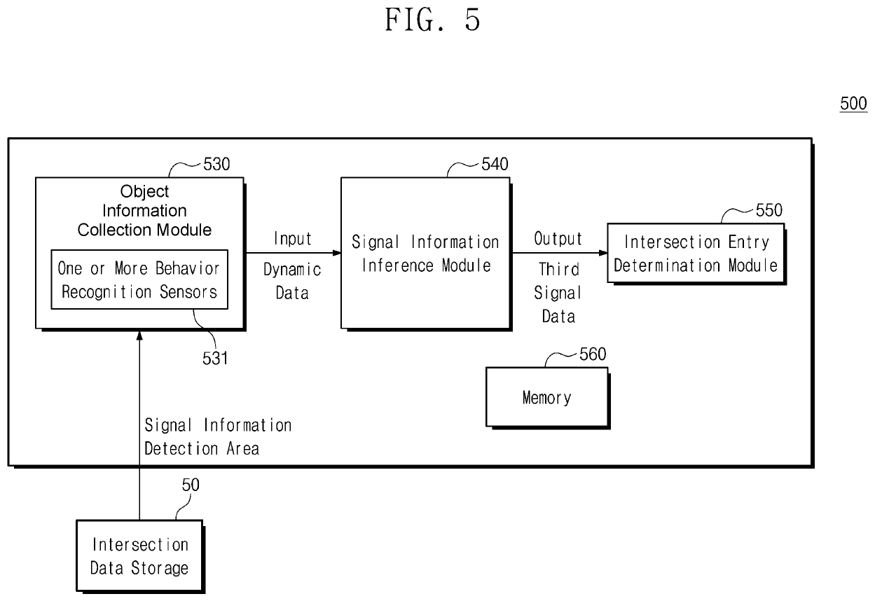

FIG. 5 relates to detailed configurations for determining whether to enter an intersection, by inferring signal information in a signal information detection area. For example, an object information collection module 530 including one or more behavior recognition sensors 531, a signal information inference module 540, an intersection entry determination module 550, a memory 560, and an intersection data storage 50 in FIG. 5 correspond to the object information collection module 130 including the one or more behavior recognition sensors 131 of FIG. 1, the signal information inference module 140 of FIG. 1, the intersection entry determination module 150 of FIG. 1, the memory 160 of FIG. 1, and the intersection data storage 20 in FIG. 2, respectively. Accordingly, additional descriptions of similar operations for each of the corresponding components will be omitted to avoid redundancy.

Referring to FIGS. 1 and 5, each of the object information collection module 530 and the signal information inference module 540 may perform the operations described in FIG. 1 based on information about the signal information detection area received from the intersection data storage 50.

In detail, after an autonomous vehicle enters the signal information detection area within an intersection, the object information collection module 530 may collect dynamic data through behavior recognition of surrounding dynamic objects. After the autonomous vehicle enters the signal information detection area within the intersection, the signal information inference module 540 may infer signal data.

After the autonomous vehicle enters the signal information detection area within the intersection, the signal information inference module 540 may infer third signal data based on the dynamic data collected by the object information collection module 530. After the autonomous vehicle enters the signal information detection area, the intersection entry determination module 550 may determine whether to enter an intersection, based on the third signal data.

When the first signal data generated by the traffic light detection module 110 is not present and the second signal data collected by the communication module 120 is not present after the autonomous vehicle enters the signal information detection area, the intersection entry determination module 550 may determine whether to enter an intersection, based on the third signal data.

The memory 560 may temporarily store data including information about the signal information detection area.

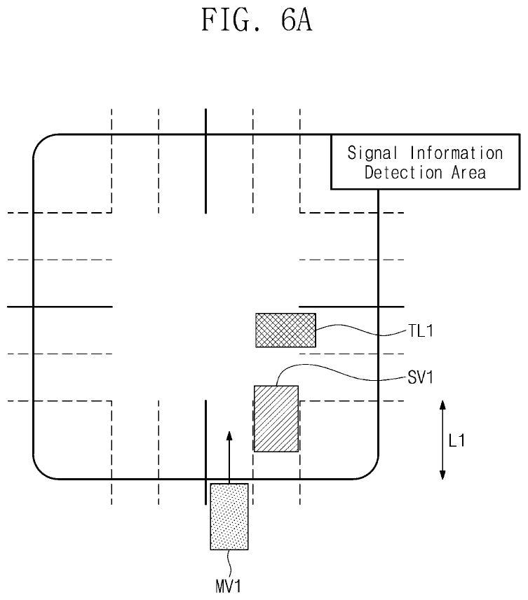

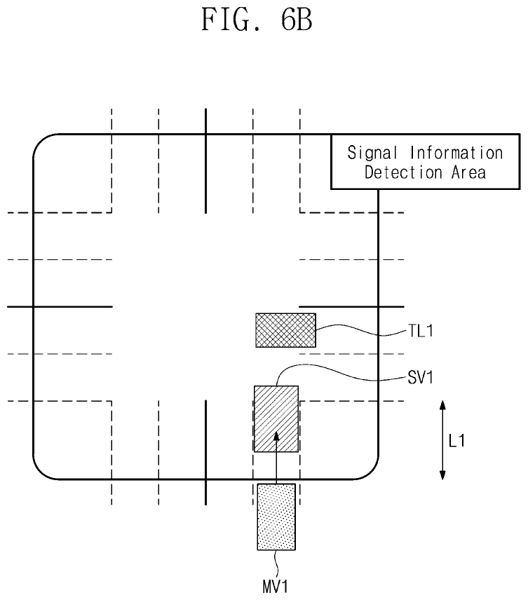

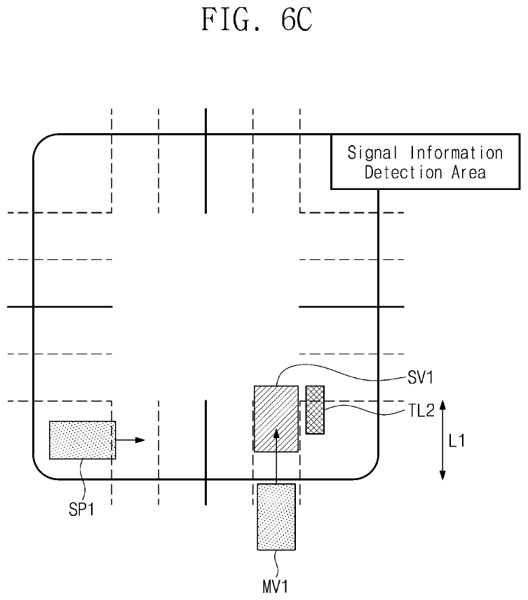

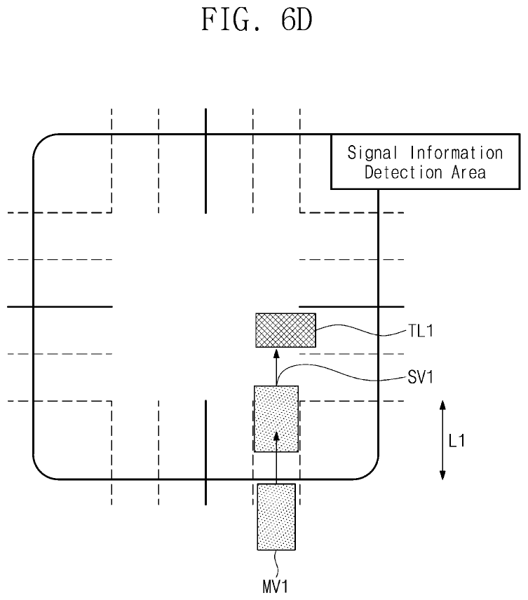

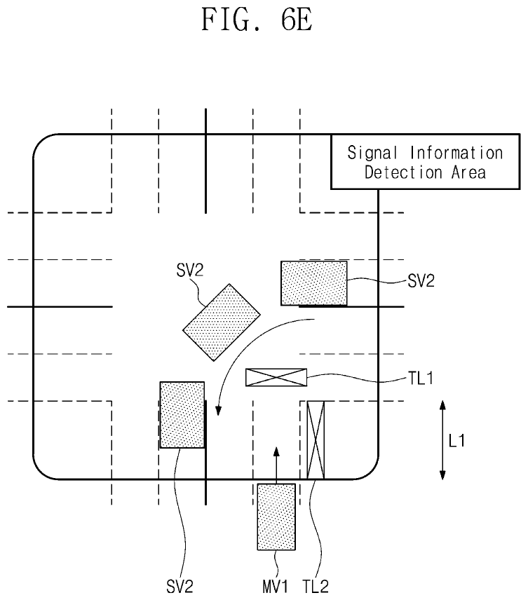

FIG. 6A relates to a first embodiment of determining whether to enter an intersection by inferring signal information in a signal information detection area. Like the illustration of FIG. 3, a signal information detection area is shown in FIG. 6A in a two-dimensional format. FIG. 6A shows an example of the surrounding vehicle SV1 that is present in a lane different from a lane of the autonomous vehicle MV1.

For example, FIG. 6A illustrates that a traffic light in a blind spot where it is impossible to recognize a traffic light is the first traffic light TL1. However, an embodiment is not limited thereto. For example, the traffic light may further include a plurality of traffic lights that are not recognized by surrounding objects or obstacles.

Referring to FIGS. 1, 5, and 6A, the autonomous vehicle MV1 equipped with the intersection traffic light information detection system 500 may generate information about the determination distance L1 through the intersection data storage 50.

When there is no surrounding object in the same lane as a lane of the autonomous vehicle MV1, the autonomous vehicle MV1 may not determine whether to enter an intersection, through object information.

Moreover, the view of the autonomous vehicle MV1 may be blocked by the surrounding vehicle SV1 stopped in a lane different from the lane of the autonomous vehicle MV1. In detail, the traffic light detection module 110 included in the intersection traffic light information detection system 100 may fail to detect the first traffic light TL1 and thus may fail to generate first signal data.

In this case, when the surrounding vehicle SV1 stopped in a lane different from the lane of the autonomous vehicle MV1 is a vehicle that does not support a V2V communication network, or a communication error occurs in the communication module 120, second signal data may not be collected.

When the first signal data or the second signal data is not present, the intersection entry determination module 550 may not determine whether to enter an intersection, through the first signal data or the second signal data.

In this case, the intersection entry determination module 550 may determine whether to enter an intersection, based on the movement of the surrounding vehicle SV1 that is present in a lane different from the lane of the autonomous vehicle MV1.

In detail, when the autonomous vehicle MV1 enters the signal information detection area based on the determination distance L1, the object information collection module 530 may collect dynamic data based on the movement of the surrounding vehicle SV1. When the surrounding vehicle SV1 is stopped or decelerating, the object information collection module 530 may collect first dynamic data reflecting a stop or deceleration state.

The signal information inference module 540 may infer third signal data based on the first dynamic data. The third signal data may include pieces of information about the type of a traffic light, whether the traffic light is turned on, and a signal direction of the traffic light.

Although not specifically shown in drawings, the signal information inference module 540 may infer that the third signal data includes pieces of information indicating that the first traffic light TL1 is a vehicle traffic light and a red light other than an arrow light is turned on.

In this case, while the autonomous vehicle MV1 is driving at the determination distance L1, the intersection entry determination module 550 may determine not to enter an intersection, based on the third signal data.

Hereinafter, FIGS. 6B to 6D show an example of the surrounding vehicle SV1 that is present in a lane the same as a lane of the autonomous vehicle MV1.

FIG. 6B relates to a second embodiment of determining whether to enter an intersection by inferring signal information in a signal information detection area. Like the illustration of FIG. 3, a signal information detection area is shown in FIG. 6B in a two-dimensional format.

For example, FIG. 6B illustrates that a traffic light in a blind spot where it is impossible to recognize a traffic light is the first traffic light TL1. However, an embodiment is not limited thereto. For example, the traffic light may further include a plurality of traffic lights that are not recognized by surrounding objects or obstacles. Accordingly, additional descriptions of similar operations for each of the similar components described in FIG. 6A will be omitted to avoid redundancy.

Referring to FIGS. 1, 5, and 6B, when the intersection traffic light information detection system 100 fails to generate first signal data and fails to collect second signal data, the object information collection module 530 may collect dynamic data based on the movement of the surrounding vehicle SV1.

When the autonomous vehicle MV1 enters the signal information detection area based on the determination distance L1, the object information collection module 530 may collect second dynamic data based on the movement of the surrounding vehicle SV1. When the surrounding vehicle SV1 is stopped, the object information collection module 530 may collect the second dynamic data reflecting the stop state.

The signal information inference module 540 may infer third signal data based on the second dynamic data. Although not specifically shown in drawings, the signal information inference module 540 may infer that the third signal data includes pieces of information indicating that the first traffic light TL1 is a vehicle traffic light and a red light other than an arrow light is turned on.

In this case, while the autonomous vehicle MV1 is driving at the determination distance L1, the intersection entry determination module 550 may determine not to enter an intersection, based on the third signal data.

FIG. 6C relates to a third embodiment of determining whether to enter an intersection by inferring signal information in a signal information detection area. Like the illustration of FIG. 3, a signal information detection area is shown in FIG. 6C in a two-dimensional format.

For example, FIG. 6C illustrates that a traffic light in a blind spot where it is impossible to recognize a traffic light is a second traffic light TL2. However, an embodiment is not limited thereto. For example, the traffic light may further include a plurality of traffic lights that are not recognized by surrounding objects or obstacles. Accordingly, additional descriptions of similar operations for each of the similar components described in FIG. 6A will be omitted to avoid redundancy.

Referring to FIGS. 1, 5, and 6C, when the intersection traffic light information detection system 100 fails to generate first signal data and to collect second signal data, the object information collection module 530 may collect dynamic data based on the movement of a surrounding pedestrian SP1. As shown in FIG. 6B, when the surrounding vehicle SV1 is stopped, the object information collection module 530 may collect the second dynamic data reflecting the stop state.

In the case where the surrounding pedestrian SP1 moves when the autonomous vehicle MV1 enters the signal information detection area based on the determination distance L1, the object information collection module 530 may collect third dynamic data by reflecting the moving state of the surrounding pedestrian SP1.

The signal information inference module 540 may infer third signal data based on the third dynamic data. Although not specifically shown in drawings, the signal information inference module 540 may infer that the third signal data includes pieces of information indicating that the second traffic light TL2 is a pedestrian traffic light and a green light other than an arrow light is turned on.

In this case, while the autonomous vehicle MV1 is driving at the determination distance L1, the intersection entry determination module 550 may determine not to enter an intersection, based on the third signal data.

FIG. 6D relates to a fourth embodiment of determining whether to enter an intersection by inferring signal information in a signal information detection area. Like the illustration of FIG. 3, a signal information detection area is shown in FIG. 6D in a two-dimensional format.

For example, FIG. 6D illustrates that a traffic light in a blind spot where it is impossible to recognize a traffic light is the first traffic light TL1. However, an embodiment is not limited thereto. For example, the traffic light may further include a plurality of traffic lights that are not recognized by surrounding objects or obstacles. Accordingly, additional descriptions of similar operations for each of the similar components described in FIGS. 6A to 6C will be omitted to avoid redundancy.

Referring to FIGS. 1, 5, and 6D, when the intersection traffic light information detection system 100 fails to generate first signal data and fails to collect second signal data, the intersection traffic light information detection system 100 may collect dynamic data based on the movement of the surrounding vehicle SV1. When the surrounding vehicle SV1 is accelerating or decelerating, the object information collection module 530 may collect dynamic data reflecting an acceleration or deceleration state.

When the autonomous vehicle MV1 enters the signal information detection area based on the determination distance L1, the object information collection module 530 may collect fourth dynamic data based on whether the surrounding vehicle SV1 accelerates.

The signal information inference module 540 may infer third signal data based on the fourth dynamic data. Although not specifically shown in drawings, when the surrounding vehicle SV1 accelerates, the signal information inference module 540 may infer that the third signal data includes pieces of information indicating that the first traffic light TL1 is a vehicle traffic light and a green light other than an arrow light is turned on.

In this case, while the autonomous vehicle MV1 is driving at the determination distance L1, the intersection entry determination module 550 may determine to enter an intersection, based on the third signal data.

When the surrounding vehicle SV1 decelerates, the signal information inference module 540 may infer that the third signal data includes pieces of information indicating that the first traffic light TL1 is a vehicle traffic light and a yellow light other than an arrow light or a red light other than an arrow light is turned on.

In this case, while the autonomous vehicle MV1 is driving at the determination distance L1, the intersection entry determination module 550 may determine not to enter an intersection, based on the third signal data.

FIG. 6E relates to a fifth embodiment of determining whether to enter an intersection by inferring signal information in a signal information detection area. Like the illustration of FIG. 3, a signal information detection area is shown in FIG. 6E in a two-dimensional format. FIG. 6E shows an example of a surrounding vehicle SV2 that is present at an intersection.

For example, FIG. 6E illustrates that traffic lights that do not operate are the first traffic light TL1 and the second traffic light TL2. However, an embodiment is not limited thereto. For example, the traffic lights may further include a plurality of traffic lights that do not operate. Accordingly, additional descriptions of similar operations for each of the similar components described in FIGS. 6A to 6D will be omitted to avoid redundancy.

Referring to FIGS. 1, 5, and 6E, when the intersection traffic light information detection system 100 fails to generate first signal data and fails to collect second signal data, the object information collection module 530 may collect dynamic data based on the movement of the surrounding vehicle SV2 that is present at an intersection. The object information collection module 530 may collect the dynamic data based on the movement of the surrounding vehicle SV2 that is present at an intersection.

When the autonomous vehicle MV1 enters the signal information detection area based on the determination distance L1, the object information collection module 530 may collect fifth dynamic data based on information about a moving direction of the surrounding vehicle SV2.

The signal information inference module 540 may infer third signal data based on the fifth dynamic data. Although not specifically shown in drawings, the signal information inference module 540 may infer that the third signal data includes pieces of information indicating that the first traffic light TL1 is a vehicle traffic light and a red light other than an arrow light is turned on. Alternatively, the signal information inference module 540 may infer that the third signal data includes pieces of information indicating that the second traffic light TL2 is a pedestrian traffic light and a green light other than an arrow light is turned on.

In this case, while the autonomous vehicle MV1 is driving at the determination distance L1, the intersection entry determination module 550 may determine not to enter an intersection, based on the third signal data.

Embodiments of inferring signal data based on dynamic data described in FIGS. 6A to 6E are only examples. The signal information inference module 540 may further infer pieces of signal data based on pieces of dynamic data of surrounding vehicles (not shown).

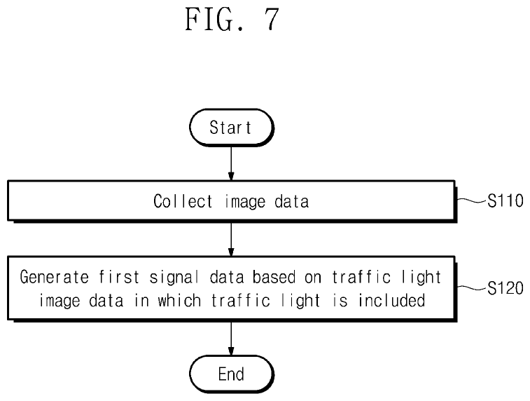

FIG. 7 is a flowchart of a method of generating first signal data.

Referring to FIGS. 1 and 7, a method of generating first signal data may include operation S110 of collecting image data and operation S120 of generating the first signal data based on traffic light image data in which a traffic light is included.

In operation S110, the image sensor 111 included in the traffic light detection module 110 may collect image data. The image sensor 111 may include at least one image sensor.

The image sensor 111 included in the traffic light detection module 110 may include at least one image sensor. At least one image sensor may be one of a charge coupled device (CCD) image sensor and a complementary metal oxide semiconductor (CMOS) image sensor.

In operation S120, the signal information generation module 112 included in the traffic light detection module 110 may generate the first signal data based on traffic light image data, in which a traffic light is included, from among the image data. The first signal data may include pieces of information about the type of a traffic light, whether the traffic light is turned on, and a signal direction of the traffic light.

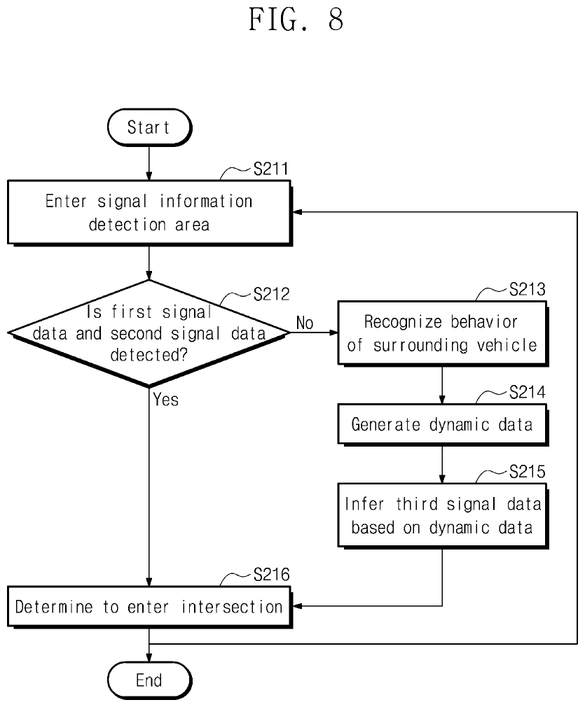

FIG. 8 is a diagram illustrating a method of detecting intersection traffic light information, according to an embodiment of the present disclosure.

Referring to FIGS. 1 and 8, an intersection traffic light information detection method includes operation S211 of entering a signal information detection area, operation S212 of detecting first signal data or second signal data, operation S213 of recognizing a behavior of a surrounding vehicle, operation S214 of generating dynamic data, operation S215 of inferring third signal data based on the dynamic data, and operation S216 of determining to enter an intersection.

In operation S211, an autonomous vehicle equipped with the intersection traffic light information detection system 100 may enter a signal information detection area. Information about the signal information detection area may be provided through the intersection data storage 10 included in an autonomous vehicle, not included in the intersection traffic light information detection system 100.

In operation S212, the intersection entry determination module 150 may detect first signal data and second signal data. As described above, the first signal data may be provided by the traffic light detection module 110. The second signal data may be received and provided by the communication module 120 from an external device or external system through a V2I communication network or a V2V communication network.

In operation S213, the object information collection module 130 may recognize the behavior of a surrounding vehicle. However, an object whose behavior is recognized by the object information collection module 130 may not be limited to a surrounding vehicle, and may include all or part of objects of which the motions are capable of being detected, as well as surrounding pedestrians or surrounding means of transportation.

In operation S214, the object information collection module 130 may generate dynamic data based on the result of recognizing a behavior of a surrounding vehicle. However, an embodiment is not limited thereto. The object information collection module 130 may generate pieces of dynamic data regarding all or part of objects of which the motions are capable of being detected, as well as surrounding pedestrians or surrounding means of transportation.

In operation S215, the signal information inference module 140 may infer third signal data based on the dynamic data. The third signal data inferred by the signal information inference module 140 may be signal data different from the first signal data and the second signal data.

In operation S216, the intersection entry determination module 150 may determine whether to enter an intersection, based on one of the first signal data, the second signal data, and the third signal data. When an intersection is entered, an operation of entering the next signal information detection area may be performed again in operation S211.

When it is determined in operation S212 that the first signal data and the second signal data are not detected, operation S213 of recognizing the behavior of the surrounding object may proceed. When it is determined in operation S212 that at least one signal data of first signal data and second signal data is detected, operation S216 for determining whether to enter an intersection, based on the first signal data or the second signal data may proceed.

The above description refers to detailed embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, a method and system for detecting intersection traffic light information may infer signal information by recognizing a behavior of a surrounding dynamic object. Accordingly, the present disclosure may prevent accidents with other vehicles, which enter an intersection, upon incompletely entering the intersection and may stably obtain signal information.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A system performing a method for detecting intersection traffic light information, the system comprising:
a traffic light detection module including an image sensor configured to generate first signal data based on traffic light image data in which a traffic light is included;
a communication module configured to receive second signal data for communication with a surrounding object and an external device;
an object information collection module configured to collect dynamic data of the surrounding object; and
a signal information inference module configured to infer third signal data based on the dynamic data,
wherein the dynamic data of the surrounding object includes at least one information of whether the surrounding object moves, a moving direction of the surrounding object, a moving speed of the surrounding object, and whether the surrounding object accelerates or decelerates, and
wherein each of the first signal data, the second signal data, and the third signal data includes pieces of information about a type of the traffic light, whether the traffic light is turned on, and a signal direction of the traffic light.

2. The system of claim 1, further comprising:
an intersection entry determination module configured to determine whether to enter an intersection, based on one signal data among the first signal data, the second signal data, and the third signal data.

3. The system of claim 2, wherein, when the first signal data and the second signal data are not present after a vehicle enters a signal information detection area, the intersection entry determination module determines whether to enter the intersection, based on the third signal data.

4. The system of claim 3, wherein, when the intersection entry determination module determines whether to enter the intersection based on the third signal data, the intersection entry determination module determines not to enter the intersection when the surrounding object that is present in the signal information detection area is stopped.

5. The system of claim 3, wherein, when the intersection entry determination module determines whether to enter the intersection based on the third signal data, the intersection entry determination module determines whether enter the intersection, based on an event that the surrounding object that is present in the signal information detection area accelerates or decelerates.

6. The system of claim 3, wherein, when the intersection entry determination module determines whether to enter the intersection based on the third signal data, the intersection entry determination module determines not to enter the intersection when the moving direction of the surrounding object that is present in the signal information detection area is perpendicular to a moving direction of the vehicle.

7. The system of claim 3, wherein, when the intersection entry determination module determines whether to enter the intersection based on the third signal data, the intersection entry determination module determines to enter the intersection when the surrounding object that is present in the signal information detection area moves at a constant speed in the same direction as the vehicle.

8. The system of claim 3, wherein, when the intersection entry determination module determines whether to enter the intersection based on the third signal data, the intersection entry determination module determines not to enter the intersection when the moving direction of the surrounding object that is present at the intersection is perpendicular to a moving direction of the vehicle.

9. The system of claim 1, wherein the first signal data, the second signal data, and the third signal data are different signal data from one another.

10. The system of claim 1, wherein the object information collection module includes at least one of radio detection and ranging (radar), light detection and ranging (LIDAR), and a camera.

11. A method for detecting intersection traffic light information, the method comprising:
generating, by a traffic light detection module, first signal data based on traffic light image data in which a traffic light is included;
receiving, by a communication module, second signal data for communication with a surrounding object and an external device;
collecting, by an object information collection module, dynamic data of the surrounding object; and
inferring, by a signal information inference module, third signal data based on the dynamic data,
wherein the dynamic data of the surrounding object includes at least one information of whether the surrounding object moves, a moving direction of the surrounding object, a moving speed of the surrounding object, and whether the surrounding object accelerates or decelerates, and
wherein each of the first signal data, the second signal data, and the third signal data includes pieces of information about a type of the traffic light, whether the traffic light is turned on, and a signal direction of the traffic light.

12. The method of claim 11, further comprising:
determining, by an intersection entry determination module, whether to enter an intersection, based on one signal data among the first signal data, the second signal data, and the third signal data.

13. The method of claim 12, wherein the determining of whether to enter the intersection includes:
when the first signal data and the second signal data are not present after a vehicle enters a signal information detection area, determining, by the intersection entry determination module, whether to enter the intersection, based on the third signal data.

14. The method of claim 13, wherein the determining, by the intersection entry determination module, of whether to enter the intersection, based on the third signal data includes:
when the surrounding object that is present in the signal information detection area is stopped, determining, by the intersection entry determination module, not to enter the intersection.

15. The method of claim 13, wherein the determining, by the intersection entry determination module, of whether to enter the intersection, based on the third signal data includes:
determining, by the intersection entry determination module, whether enter the intersection, based on an event that the surrounding object that is present in the signal information detection area accelerates or decelerates.

16. The method of claim 13, wherein the determining, by the intersection entry determination module, of whether to enter the intersection, based on the third signal data includes:
when the moving direction of the surrounding object that is present in the signal information detection area is perpendicular to a moving direction of the vehicle, determining, by the intersection entry determination module, not to enter the intersection.

17. The method of claim 13, wherein the determining, by the intersection entry determination module, of whether to enter the intersection, based on the third signal data includes:
when the surrounding object that is present in the signal information detection area moves at a constant speed in the same direction as the vehicle, determining, by the intersection entry determination module, to enter the intersection.

18. The method of claim 13, wherein the determining, by the intersection entry determination module, of whether to enter the intersection, based on the third signal data includes:
when the moving direction of the surrounding object that is present at the intersection is perpendicular to a moving direction of the vehicle, determining, by the intersection entry determination module, not to enter the intersection.

19. The method of claim 11, wherein the first signal data, the second signal data, and the third signal data are different signal data from one another.
